(19) United States
(12) Patent Application Publication
(10) Pub. No.: US 2025/0314321 A1
(43) Pub. Date: Oct. 9, 2025

(54) Valve Assembly and Plunger Pump

(71) Applicant: YANTAI JEREH PETROLEUM EQUIPMENT & TECHNOLOGIES CO., LTD., Yantai (CN)

(72) Inventors: Xiaobin LI, Yantai (CN); Peng LI, Yantai (CN); Baojie WANG, Yantai (CN); Jixin WANG, Yantai (CN); Baoguo JIAN, Yantai (CN); Chen JIANG, Yantai (CN); Zimeng GUO, Yantai (CN); Xiaoguang WANG, Yantai (CN); Zhifei TIAN, Yantai (CN); Cheng XU, Yantai (CN); Yu QU, Yantai (CN)

(73) Assignee: YANTAI JEREH PETROLEUM EQUIPMENT & TECHNOLOGIES CO., LTD., Yantai (CN)

(21) Appl. No.: 19/244,979

(22) Filed: Jun. 20, 2025

Related U.S. Application Data
(63) Continuation-in-part of application No. PCT/CN2022/132670, filed on Nov. 17, 2022.

(30) Foreign Application Priority Data
May 26, 2022 (CN) 202221290416.8
Jun. 6, 2025 (CN) 202521157700.1
Jun. 6, 2025 (CN) 202521157890.7

(51) Int. Cl. F16K 25/00; F04B 53/22; F16K 1/36; F16K 1/42

(52) U.S. Cl. CPC F16K 25/005; F04B 53/22; F16K 1/36; F16K 1/425

(57) ABSTRACT

A valve assembly and a plunger pump are disclosed. In one example, the valve assembly includes a valve seat, a valve body, valve rubber, and a wear-resistant ring, where the valve seat is provided with a guide cavity, the valve body includes a guide claw and an attachment disc which are fixedly connected, the guide claw is in sliding fit with the guide cavity, the attachment disc is provided with a mounting groove, the valve rubber is embedded in the mounting groove, the wear-resistant ring is made of a wear-resistant material, hardness of the wear-resistant ring is greater than hardness of the valve seat, the wear-resistant ring and the valve seat are relatively fixed, and in a case that the valve assembly is in a closed state, the attachment disc and the valve rubber are both attached to a surface of the wear-resistant ring.

### CROSS-REFERENCE TO RELATED APPLICATIONS

The patent application is a continuation-in-part of and claims the benefit of priority to PCT Application No. PCT/CN2022/132670, filed on Nov. 17, 2022, which is based on and claims the benefit of priority to Chinese Patent Application No. 202221290416.8, filed with the Chinese Patent Office on May 26, 2022 and entitled “Valve assembly and plunger pump.” This application further claims the benefit of priority to Chinese Patent Applications Nos. 202521157700.1 and 202521157890.7 both filed on Jun. 6, 2025. These prior patent applications are incorporated herein in their entirety by reference.

### TECHNICAL FIELD

The disclosure relates to the technical field of oil exploitation, and particularly relates to a valve assembly and a plunger pump.

### BACKGROUND

A plunger pump is a type of common engineering device with a hydraulic end and a power end. When the plunger pump operates, the hydraulic end can exchange power with the power end. The hydraulic end is generally provided with a valve assembly such that liquid can be pumped by opening and closing the valve assembly. At present, the valve assembly includes a valve seat, a valve body, and valve rubber. The valve rubber sleeves the valve body, the valve body is mounted in the valve seat, and the valve body and the valve rubber match the valve seat. When the valve body and the valve rubber are attached to a top surface of the valve seat, the valve assembly is closed. When the valve body and the valve rubber slide relative to the valve seat and get separated from the top surface of the valve seat, the valve assembly is opened. With an increase of operating time of the valve assembly, since the valve body collides with the valve seat for a long time, the valve seat is likely to be severely worn and required to be replaced. However, the valve seat is generally mounted in a valve box of the plunger pump in an interference fit manner, such that it is laborious to replace the valve seat.

### SUMMARY

The disclosure discloses a valve assembly and a plunger pump, to solve the problems that at present, since a valve seat collides with a valve body for a long time, the valve seat is likely to be worn and required to be replaced, and it is laborious to replace the valve seat.

To solve the above problems, the disclosure employs a technical solution as follows.

In a first aspect, the disclosure discloses a valve assembly. The valve assembly includes a valve seat, a valve body, valve rubber, and a wear-resistant ring. The valve seat is provided with a guide cavity. The valve body includes a guide claw and an attachment disc which are fixedly connected. The guide claw is in sliding fit with the guide cavity. The attachment disc is provided with a mounting groove. The valve rubber is embedded in the mounting groove. The wear-resistant ring is made of a wear-resistant material. Hardness of the wear-resistant ring is greater than hardness of the valve seat. The wear-resistant ring and the valve seat are relatively fixed. In a case that the valve assembly is in a closed state, the attachment disc and the valve rubber are both attached to a surface of the wear-resistant ring.

In a second aspect, a stepless split valve seat for a fracturing plunger pump modifies a traditional step-type valve seat structure, removes the step support surface structure of the valve seat, and is designed as a stepless structure. Such a valve seat is composed of a valve seat base and two liner rings. The two liner rings are installed on the valve seat base, and are located on the impact surface between the valve seat and the valve body assembly (including the valve body and the valve rubber). The hardness of the two liner rings is higher than that of the valve seat base, thereby making the impact surface between the valve seat and the valve body assembly more wear-resistant, thereby achieving the effect of extending the overall life of the valve seat.

In another aspect, a valve seat for a plunger pump is disclosed. Compared with a conventional valve seat having a stepped valve seat structure, the disclosed embodiment removes the step structure of the valve seat. The collision surface at the conical surface position of the valve seat and the erosion surface at the inner cavity position of the valve seat are designed as an embedded hard alloy component to improve the wear resistance, erosion resistance and impact resistance of the collision surface and the erosion surface. Specifically, two independent hard alloy bushings are disposed at the collision surface and the erosion surface position.

In a second aspect, the disclosure discloses a plunger pump. The plunger pump includes a valve box and the above valve assembly. The valve box is provided with a limiting cavity. The valve seat is arranged in the limiting cavity in an interference fit manner.

### BRIEF DESCRIPTION OF THE DRAWINGS

Accompanying drawings described herein serve as a constitute part of the disclosure to provide further understanding of the disclosure. Illustrative embodiments of the disclosure and their descriptions are used to explain the disclosure, and are not to be construed as unduly limiting the disclosure. In accompanying drawings,

FIG. 1 is a sectional view of a structure in which a wear-resistant ring is included in a valve assembly disclosed in an embodiment of the disclosure;

FIG. 2 is an assembly diagram of the valve assembly shown in FIG. 1;

FIG. 3 is a sectional view of another structure in which a wear-resistant ring is included in a valve assembly disclosed in an embodiment of the disclosure;

FIG. 4 is an assembly diagram of the valve assembly shown in FIG. 3;

FIG. 5 is a sectional view of yet another structure in which a wear-resistant ring is included in a valve assembly disclosed in an embodiment of the disclosure;

FIG. 6 is an assembly diagram of the valve assembly shown in FIG. 5;

FIG. 7 is a sectional view of still another structure in which a wear-resistant ring is included in a valve assembly disclosed in an embodiment of the disclosure;

FIG. 8 is an assembly diagram of the valve assembly shown in FIG. 7;

FIG. 9 illustrates an example fluid end of a plunger pump;

FIG. 10 illustrates an example valve assembly;

FIG. 11 illustrates and example valve seat;

FIG. 12 illustrates another view of a valve seat;

FIG. 13 illustrates another example valve seat;

FIG. 14 illustrates another example valve seat;

FIG. 15 illustrates another example valve seat;

FIG. 16 illustrates an example fluid end of a plunger pump;

FIG. 17 illustrates example valve seat components;

FIG. 18 illustrates an expanded view of the valve assembly of FIG. 16;

FIG. 19 illustrates am example portion of a valve box;

FIG. 20 illustrates an example installation of a valve assembly with a valve box; and

FIG. 21 illustrates another example installation of a valve assembly with a valve box.

### DETAILED DESCRIPTION

To make objectives, technical solutions, and advantages of the disclosure clearer, the technical solutions of the disclosure will be described below in combination with particular embodiments and corresponding accompanying drawings of the disclosure. Apparently, the described embodiments are mere examples. Based on embodiments of the disclosure, all other embodiments obtained by those of ordinary skill in the art without making creative efforts fall within the scope of protection of the disclosure.

Technical solutions disclosed in various embodiments of the disclosure will be described in detail below in combination with accompanying drawings.

As shown in FIG. 1 to FIG. 8, embodiments of the disclosure disclose a valve assembly and a plunger pump. The valve assembly may be applied to the plunger pump. The plunger pump includes a valve box 600. The valve box 600 is provided with a limiting cavity. The valve assembly may be mounted in the limiting cavity of the valve box 600. The plunger pump may generally include other mechanisms such as a plunger and a connecting rod, which will not be listed herein for brevity of text.

As shown in FIG. 1 to FIG. 8, the valve assembly disclosed in an example embodiment of the disclosure includes a valve seat 100, a valve body 200, valve rubber 300, and a wear-resistant ring 400. The valve seat 100 may serve as a mounting base of the valve assembly. Other components of the valve assembly may be directly or indirectly mounted to the valve seat 100. Moreover, the valve seat 100 is provided with a guide cavity such that guidance and limitation actions can be provided for the valve body 200 through the guide cavity. A specific shape and size of the guide cavity can be determined according to actual situations.

Specifically, the valve seat 100 may be generally formed of a metal material such that the valve seat 100 can be ensured to have relatively reliable structural stability. When the valve assembly is mounted, the valve seat 100 may be generally fixed in the limiting cavity of the valve box 600 in an interference fit manner. Thus, a material of the valve seat 100 is required to have particular toughness such that the valve seat 100 can be ensured to be assembled into the limiting cavity of the valve box 600 through slight deformation.

The valve body 200 and the valve rubber 300 can be regarded as a “valve core” of the valve assembly. The valve assembly can be switched between an open state and a closed state by moving the valve body 200 and the valve rubber 300 relative to the valve seat 100. The valve body 200 includes a guide claw and an attachment disc. The guide claw and the attachment disc are fixedly connected such that the valve body 200 can be ensured to move as a whole relative to the valve seat 100. The guide claw is in sliding fit with the guide cavity such that guidance and limitation effects can be provided for the valve body 200. The guide claw may specifically include a plurality of claws. The plurality of claws are uniformly distributed at intervals in an axial direction of the valve seat 100 such that the guide claw can be ensured to provide a stable and reliable guidance action for the valve body 200.

On the one hand, the attachment disc may serve as a component for sealing the valve body 200 and the valve seat 100. On the other hand, the attachment disc can provide a mounting action for the valve rubber 300. Specifically, the attachment disc is provided with a mounting groove. The valve rubber 300 is embedded in the mounting groove, such that the valve rubber 300 and the valve body 200 are connected as a whole and move together relative to the valve seat 100. Thus, the valve assembly can be switched between an open state and a closed state. The attachment disc may be made of a hard material such as metal. A specific shape and size of the attachment disc can be determined according to actual requirements, which will not be limited herein. The valve rubber 300 may be formed of an elastic material such as rubber. The valve rubber 300 may sleeve the attachment disc. Moreover, the valve rubber 300 is embedded in the mounting groove. To ensure the valve rubber 300 to serve as a sealing structure, after the valve rubber 300 is embedded in the mounting groove, it is required to ensure the valve rubber 300 to have a similar attachment ability to a surface of the attachment disc such that a corresponding sealing action can be provided for the valve assembly.

As mentioned above, the valve assembly disclosed in an embodiment of the disclosure includes a wear-resistant ring 400. The wear-resistant ring 400 is made of a wear-resistant material such that wear resistance of the wear-resistant ring 400 can be relatively high. Moreover, hardness of the wear-resistant ring 400 is greater than hardness of the valve seat 100. On the premise of ensuring the wear-resistant ring 400 to have relatively high wear resistance, by making the hardness of the valve seat 100 relatively low, on the one hand, the valve seat 100 can be ensured to have relatively high toughness such that an interference fit relationship can be formed between the valve seat 100 and the valve box 600. On the other hand, material cost and processing cost of the valve seat 100 can be made relatively low. Thus, on the premise of ensuring the valve assembly to have an excellent overall performance, cost of the valve assembly is reduced to a certain extent, and product competitiveness is improved. More specifically, the wear-resistant ring 400 is formed of a material including one of zirconium oxide, nickel-based tungsten carbide, cobalt-based tungsten carbide, titanium carbide, and boron nitride. These materials have relatively low acquisition difficulty and cost, and all have relatively excellent hardness and wear resistance.

When the valve assembly is assembled, the wear-resistant ring 400 and the valve seat 100 are relatively fixed such that a prerequisite can be provided for a sealing relationship between the valve body 200, the valve rubber 300, and the wear-resistant ring 400. Specifically, a direct connection relationship may be formed between the wear-resistant ring 400 and the valve seat 100 by a connector, etc., such that the valve seat and the wear-resistant ring can be relatively fixed. A relative fixation relationship may be formed between each of the valve seat 100 and the wear-resistant ring 400, and another component such as the valve box 600 through other methods. In this way, a relative fixation relationship can be ensured to be formed between the valve seat 100 and the wear-resistant ring 400.

In a case that the valve assembly disclosed in the above embodiment is in a closed state, the attachment disc and the valve rubber 300 are both attached to the surface of the wear-resistant ring 400. Furthermore, in the valve assembly disclosed in an embodiment of the disclosure, the wear-resistant ring 400 is the component making contact with both the attachment disc and the valve rubber 300. Since the wear-resistant ring 400 has relatively high wear resistance and hardness, the wear-resistant ring 400 can be ensured to have a relatively long service life. Moreover, since the valve seat 100 does not make contact with the valve body 200 and the valve rubber 300 any more, the valve seat 100 cannot be easily worn. Thus, the service life of the valve seat 100 can be prolonged, a replacement cycle of the valve seat 100 can be prolonged, and labor expenditure can be reduced. In addition, in the valve assembly disclosed in an embodiment of the disclosure, part of the structure of the valve seat 100 is replaced with only the wear-resistant ring 400, and most of the structure of the valve seat 100 is still retained. On the one hand, the valve assembly can be conveniently mounted to the valve box 600. On the other hand, cost of the valve assembly cannot be affected basically.

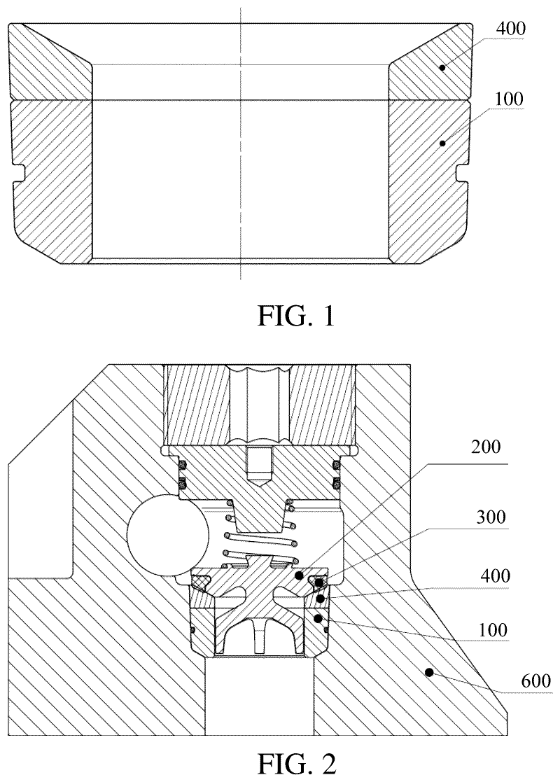

As mentioned above, the valve seat 100 is provided with a guide cavity, such that the valve seat 100 is actually an annular structural member. In a particular embodiment, as shown in FIG. 1 and FIG. 2, the valve seat 100 and the wear-resistant ring 400 are distributed in the axial direction of the valve seat 100. That is, the valve seat 100 is located as a whole on a side of the wear-resistant ring 400. Correspondingly, the wear-resistant ring 400 is located as a whole on a side of the valve seat 100. In the embodiment, the wear-resistant ring 400 may be mounted to the valve box 600 in an interference fit manner such that a stable fixed relationship can be formed between the wear-resistant ring 400 and the valve seat 100. Moreover, in this case, since the valve seat 100 is located as a whole on a side of the wear-resistant ring 400 facing away from the attachment disc of the valve body 200, both the valve body 200 and the valve rubber 300 can be ensured to not make contact with the valve seat 100, and service life of the valve seat 100 can be prolonged as much as possible.

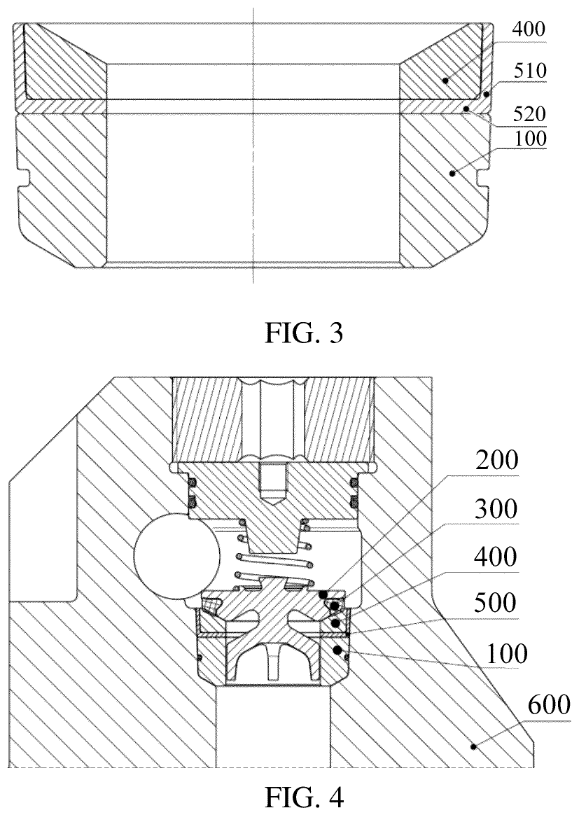

As mentioned above, the hardness of the wear-resistant ring 400 is relatively greater than the hardness of the valve seat 100. Thus, based on the above embodiment, as shown in FIG. 3 and FIG. 4, the valve assembly disclosed in an embodiment of the disclosure further includes a buffer ring 510. Hardness of the buffer ring 510 is less than the hardness of the wear-resistant ring 400. The buffer ring 510 is arranged around a periphery of the wear-resistant ring 400. Furthermore, when the valve assembly disclosed in an embodiment of the disclosure is assembled, some buffering actions can be provided for the wear-resistant ring 400 by the buffer ring 510. Thus, a difficulty of forming an interference fit relationship between the wear-resistant ring 400 and the valve box 600 can be reduced.

Certainly, the above buffer ring 510 is also required to be made of a hard material. However, since the hardness of the buffer ring 510 is less than the hardness of the wear-resistant ring 400, compared with the wear-resistant ring 400, the buffer ring 510 has a buffering ability under the action of its own toughness, and is embedded in a gap between the wear-resistant ring 400 and the valve box 600. More specifically, the buffer ring 510 may be made of the same material as the valve seat 100. Moreover, a specific size of the buffer ring 510 can be determined correspondingly according to sizes such as an outer diameter of the wear-resistant ring 400 and an inner diameter of the valve box 600 such that the wear-resistant ring 400 can be ensured to be embedded in the buffer ring 510. Furthermore, the buffer ring 510 may be embedded between the wear-resistant ring 400 and the valve box 600.

In a case that the valve assembly includes the buffer ring 510, in some example implementations, the valve assembly may further include a buffer pad 520. The hardness of the buffer pad 520 is less than the hardness of the wear-resistant ring 400. The buffer pad 520 and the buffer ring 510 are fixedly connected to form a buffer member 500. Thus, an improving action is provided for structural stability of the buffer ring 510 by the buffer pad 520. The situation that the buffer ring 510 is broken when the buffer ring 510 is in interference fit with the wear-resistant ring 400 can be prevented. Moreover, since the hardness of the buffer pad 520 is less than the hardness of the wear-resistant ring 400, and a deformation quantity of the buffer ring 510 is extremely small when the buffer ring 510 is in interference fit with the wear-resistant ring 400, a deformability of the buffer ring 510 cannot be greatly affected when the buffer pad 520 is fixedly connected to the buffer ring 510. Specifically, in a case that the buffer pad 520 and the buffer ring 510 are both formed of metal materials, the buffer pad 520 and the buffer ring 510 may be fixedly connected through welding. In another embodiment of the disclosure, the buffer pad 520 and the buffer ring 510 may be a structural member integrally formed. That is, the buffer pad 520 and the buffer ring 510 are integrally formed. Thus, a difficulty of processing the buffer pad and the buffer ring can be reduced. Moreover, reliability of a connection between the buffer pad 520 and the buffer ring 510 can be improved, and a deformation performance of the buffer ring 510 can be improved.

In a case that the valve assembly includes the buffer ring 510 and the buffer pad 520, the buffer pad 520 may be laid between the valve seat 100 and the wear-resistant ring 400. In this case, on the one hand, a limiting action can be provided for the buffer pad 520 and the buffer ring 510 by the wear-resistant ring 400 and the valve seat 100. On the other hand, an isolation action can be provided between the valve seat 100 and the wear-resistant ring 400 by the buffer pad 520. Thus, the situation that the wear-resistant ring 400 excessively presses the valve seat 100 when the wear-resistant ring 400 is assembled can be prevented, and service life of the valve seat 100 can be further prolonged.

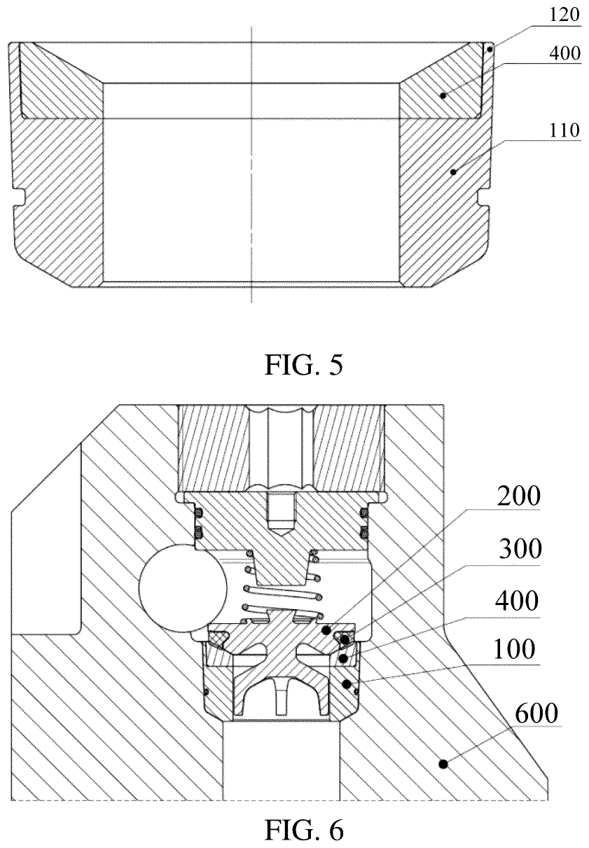

As mentioned above, since the wear-resistant ring 400 has relatively great hardness, a difficulty is relatively large when the wear-resistant ring 400 and the valve box 600 are assembled in an interference fit manner, and the wear-resistant ring 400 may not be favorably assembled in place. Thus, as shown in FIG. 5 and FIG. 6, in another embodiment of the disclosure, the valve seat 100 includes a seat body 110 and a buffer portion 120. The seat body 110 and the buffer portion 120 are fixedly connected. The buffer portion 120 is arranged around a periphery of the wear-resistant ring 400. Thus, when the valve assembly disclosed in an embodiment of the disclosure is assembled, some buffering actions can be provided for the wear-resistant ring 400 by the buffer portion 120, and a difficulty of forming an interference fit relationship between the wear-resistant ring 400 and the valve box 600 can be reduced.

The above buffer portion 120 may be a part of the valve seat 100. Although the hardness of the valve seat 100 is less than the hardness of the wear-resistant ring 400, the valve seat 100 is also required to be formed of a hard material. However, since the hardness of the valve seat 100 is less than the hardness of the wear-resistant ring 400, compared with the wear-resistant ring 400, the buffer portion 120 of the valve seat 100 can provide a buffering ability for the wear-resistant ring 400 under the action of its own toughness. Moreover, assembly stability of the wear-resistant ring 400 can be improved.

Specifically, a thickness of the buffer portion 120 can be determined according to sizes such as an outer diameter of the wear-resistant ring 400 and an inner diameter of the valve box 600 such that the wear-resistant ring 400 can be ensured to be embedded in the buffer portion 120. Moreover, the buffer portion 120 may be embedded between the wear-resistant ring 400 and the valve box 600. The buffer portion 120 and the seat body 110 may be formed through split forming. In a case that the buffer portion and the seat body are both formed of metal materials, the buffer portion 120 may be fixed, through welding, to a side of the seat body 110 where the wear-resistant ring 400 is located. In another embodiment of the disclosure, the seat body 110 and the wear-resistant ring 400 are integrally formed such that reliability of a connection between the seat body and the wear-resistant ring can be improved. Moreover, structural stability of the buffer portion 120 can be improved.

In a case that the above technical solution is used, the inner diameter of the valve box 600 and the outer diameter of the wear-resistant ring 400 can be increased such that it can be ensured that after the valve assembly is assembled, the valve body 200 and the valve rubber 300 both make contact with only the wear-resistant ring 400. Specifically, the outer diameter of the wear-resistant ring 400 can be equal to or greater than a maximum diameter of a part of the valve body 200 and the valve rubber 300 for making contact with the wear-resistant ring 400.

Based on the above embodiments, to prevent the buffer portion 120 from interfering with a process of pumping a liquid by the valve assembly as much as possible, in some example implementations, as shown in FIG. 5, the buffer portion 120 may be flush with the outer edge of the wear-resistant ring 400 in the axial direction of the valve seat 100. In a case that such a technical solution is used, the buffer portion 120 can be ensured to provide a relatively comprehensive buffering action for the wear-resistant ring 400. Furthermore, an effect of assembling any position of the wear-resistant ring 400 to the valve box 600 can be basically the same, and positional stability of the wear-resistant ring 400 can be improved.

In addition, in the above embodiment that the valve assembly includes the buffer ring 510, the buffer ring 510 may also be flush with the outer edge of the wear-resistant ring 400 in the axial direction of the valve seat 100 such that positional stability of the wear-resistant ring 400 can be improved, and the buffer ring 510 can be prevented from interfering with pumping of a liquid by the valve assembly.

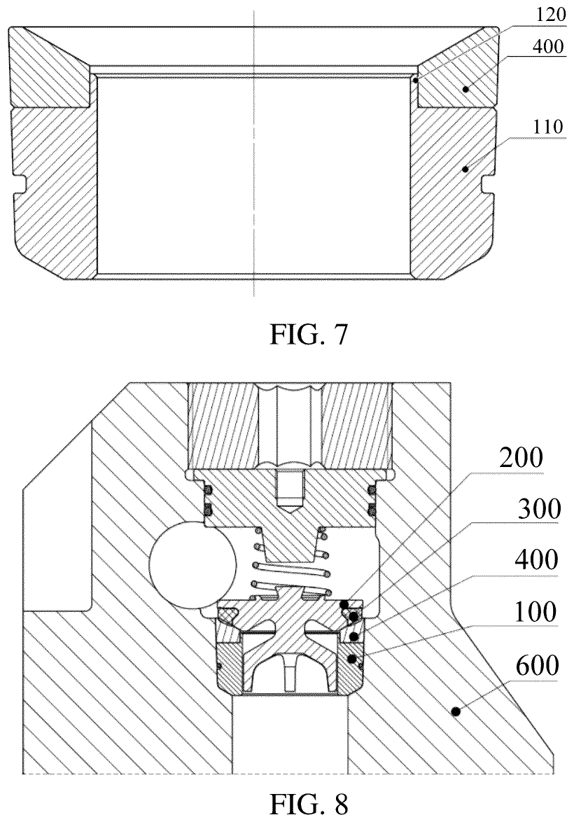

As mentioned above, since the wear-resistant ring 400 has relatively great hardness, a difficulty is relatively large when the wear-resistant ring 400 and the valve box 600 are assembled in an interference fit manner, and the wear-resistant ring 400 may not be favorably assembled in place. Thus, as shown in FIG. 7 and FIG. 8, in another embodiment of the disclosure, the valve seat 100 includes a seat body 110 and a buffer portion 120. The seat body 110 and the buffer portion 120 are fixedly connected. The buffer portion 120 is embedded in the inner cavity of the wear-resistant ring 400. Furthermore, when the valve assembly disclosed in an embodiment of the disclosure is assembled, a relatively weak press state can be formed between the outer edge of the wear-resistant ring 400 and the valve box 600, and some buffering actions can be provided for the wear-resistant ring 400 by the buffer portion 120 such that the wear-resistant ring 400 and the buffer portion 120 can form a relatively strong press state. The wear-resistant ring 400 can be ensured to be stably fixed to a corresponding position of the valve box 600, and a difficulty of forming an interference fit relationship between the wear-resistant ring 400 and the valve box 600 can be reduced.

Certainly, the above buffer portion 120 is a part of the valve seat 100. Although the hardness of the valve seat 100 is less than the hardness of the wear-resistant ring 400, the valve seat 100 is also required to be formed of a hard material. However, since the hardness of the valve seat 100 is less than the hardness of the wear-resistant ring 400, compared with the wear-resistant ring 400, the buffer portion 120 of the valve seat 100 can provide a buffering ability for the wear-resistant ring 400 under the action of its own toughness. Moreover, assembly stability of the wear-resistant ring 400 can be improved.

Specifically, a thickness of the buffer portion 120 can be determined according to a flow rate of the valve assembly and a size such as an inner diameter of the wear-resistant ring 400 such that the wear-resistant ring 400 can be ensured to be embedded in the valve box 600. Moreover, the buffer portion 120 may be embedded in the inner cavity of the wear-resistant ring 400. The buffer portion 120 and the seat body 110 may be formed through split forming. In a case that the buffer portion and the seat body are both formed of metal materials, the buffer portion 120 may be fixed, through welding, to a side of the seat body 110 where the wear-resistant ring 400 is located. In another embodiment of the disclosure, the seat body 110 and the wear-resistant ring 400 are integrally formed such that reliability of a connection between the seat body and the wear-resistant ring can be improved. Moreover, structural stability of the buffer portion 120 can be improved.

In a case that the above technical solution is used, the inner diameter of the valve box 600 and the inner diameter of the wear-resistant ring 400 can be increased such that it can be ensured that after the valve assembly is assembled, the valve body 200 and the valve rubber 300 both make contact with only the wear-resistant ring 400. Specifically, the inner diameter of the wear-resistant ring 400 can be made less than or equal to a minimum diameter of a part of the valve body 200 for making contact with the wear-resistant ring 400.

Based on the above embodiments, to further prevent the situation that the valve body 200 may make contact with the buffer portion 120 having relatively low hardness to damage the buffer portion 120 when the valve assembly operates, in some example implementations, as shown in FIG. 7 and FIG. 8, the buffer portion 120 may be recessed relative to the inner edge of the wear-resistant ring 400 toward the side away from the attachment disc in the axial direction of the valve seat 100. In a case that such a technical solution is used, a probability that the valve body 200 makes contact with the buffer portion 120 can be further reduced, the situation that the buffer portion 120 collides with the valve body 200 to be damaged can be further prevented, and service life of the valve seat 100 can be prolonged. Specifically, a recess size of the buffer portion 120 relative to the wear-resistant ring 400 in the axial direction of the valve seat 100 can be determined according to actual situations, and the aforementioned size may be made relatively small as far as possible such that the buffer portion 120 can be ensured to provide a more comprehensive buffering action for the wear-resistant ring 400, and positional stability of the wear-resistant ring 400 can be improved.

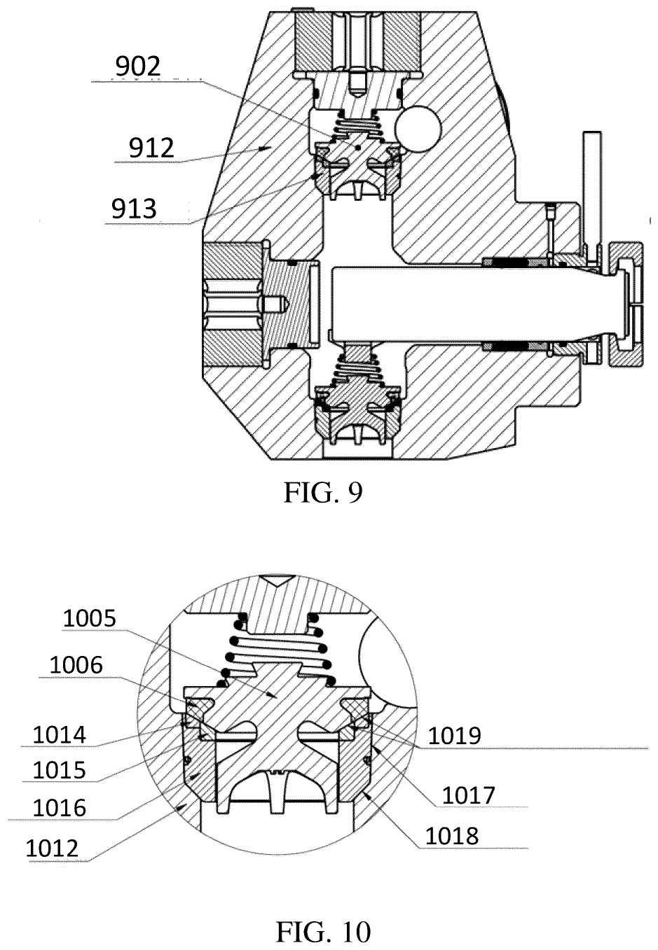

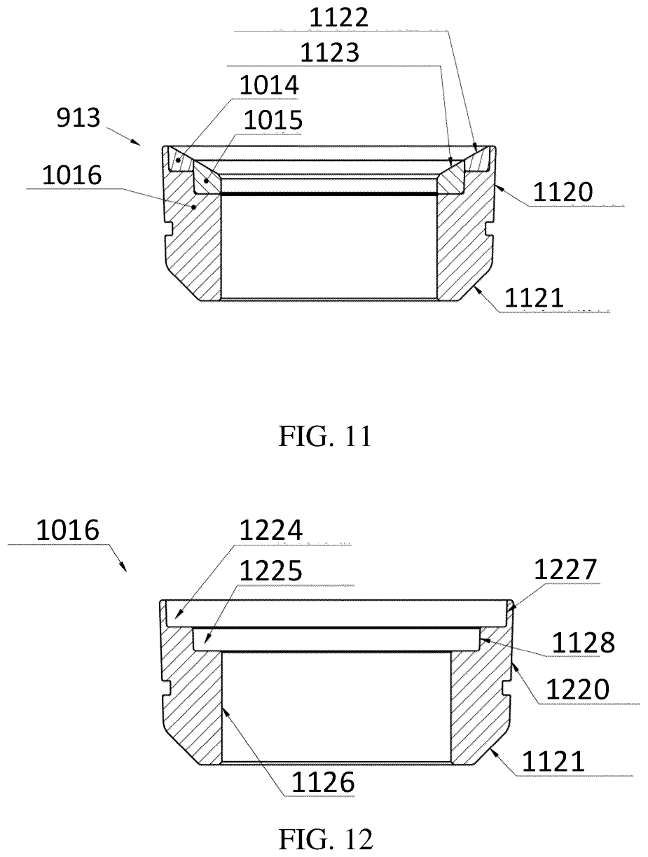

In some other embodiment, as shown in FIGS. 9-12, a stepless split valve seat 913 may be implemented. The valve seat structure may include a valve seat base 1016, a large liner ring 1014 (outer liner ring), and a small liner ring 1015 (or inner liner ring), in a double-ring configuration. The large liner ring 1014 may be installed in a large liner ring installation groove 1224 of the valve seat base 1016, and there may be an interference fit between the large liner ring 1014 and the large liner ring installation groove 1224, which can adopt one of a cylindrical interference fit, a conical interference fit, or other interference fit methods. The small liner ring 1015 may be installed in the small liner ring installation groove 1225 of the valve seat base 1016 (alternatively referred to as valve seat base), and there may be an interference fit between the small liner ring 1015 and the small liner ring installation groove 1225, which can adopt a cylindrical interference fit, a conical interference fit, or other interference fit methods.

After the large liner ring 1014 and the small liner ring 1015 are assembled on the valve seat base 1016, the large liner ring 1014, the small liner ring 1015, and the valve body assembly 902 are combined to form the impact surface 1019 of the valve seat 913 and the valve body assembly 902. During operation, the large liner ring 1014 and the small liner ring 1015 may collide with the valve body assembly 902 (including the valve body 1005 and the valve rubber 1006). The hardness of the large liner ring 1014 and the small liner ring 1015 may be higher than that of the valve seat base 1016, with higher wear resistance. The material selection of the large liner ring 1014 (liner ring is alternative referred to as lining ring) and the small liner ring 1015 may include but is not limited to the following materials: zirconium oxide, nickel-based tungsten carbide, cobalt-based tungsten carbide, titanium carbide, boron nitride, ceramics, and the like.

In the structural design above of the valve seat 913 in FIGS. 9-12, two lining rings are independently designed, namely a large lining ring 1014 and a small lining ring 1015. The large lining ring 1014 is mainly in contact with the valve rubber 1006, and the small lining ring 1015 is mainly in contact with the valve body 1005. The reasons for the independent design of two lining rings in this example implementation are as follows.

First, the collision surface between the valve seat 913 and the valve body assembly 902 (including the valve body and the valve rubber) can be divided into two parts, one part being in contact with the valve body 1005, and the other part being in contact with the valve rubber 1006. The valve body 1005 has a high hardness, while the valve rubber 1006 is a non-metallic part with a relatively soft hardness. During use, the depression of the impact surface between the valve seat 913 and the valve body 1005 is deeper than the depression of the impact surface between the valve seat 913 and the valve rubber 1006. Therefore, the position of the impact surface between the valve seat 913 and the valve body 1005 directly determines the life of the valve seat 913. In order to solve the depression problem of the impact surface between the valve seat 913 and the valve body 1005, the valve seat 913 in the inner part may include a lining ring embedded in the position of the collision surface with the valve body 1005, but not in the position of the collision surface of with the valve rubber 1006. With such an implementation, after the valve seat collides with the valve body assembly 902 for a long time, the severely depressed part would be the collision surface of the valve seat 913 and the valve rubber 1006, while the collision surface cooperating with the valve body 1005 is less depressed. Therefore, the position of the collision surface of the valve seat 913 and the valve rubber 1006 directly determines the collision of the valve seat life. So, it may be necessary to make improvements to further improve the overall life of the valve seat. In some example implementations as described above, two lining rings on the valve seat base 1016 may be installed, including the large lining ring 1014 and the small lining ring 1015. The two lining rings are located on the impact surface 1019 of the valve seat 913 and the valve body assembly 902. The hardness of these two lining rings is higher than that of the valve seat base 1016, so that the impact surface 1019 of the valve seat 913 and the valve body assembly 902 is more wear-resistant, thereby achieving the effect of extending the overall life of the valve seat.

Second, during the use of the valve seat 1016, since the degree of wear between the impact surface of the valve seat 913 and the valve body 1005 and the degree of wear between the impact surface of the valve seat 913 and the valve rubber 6 are different, this will cause a height difference between the two impact surfaces, that is, the so-called depression. When the depression reaches a certain degree, it will affect the life of the valve body assembly 902, and then the valve seat 913 needs to be replaced. The two liner rings (parts 1014 and 1015) on the valve seat 913 as implemented above are independent of each other. The hardness of the two liner rings (parts 1014 and 1015) can be adjusted according to actual conditions to make the degree of wear of the impact surface between the large liner ring 1014 and the valve rubber 1006 and the degree of wear of the impact surface between the small liner ring 1015 and the valve body 1005 as consistent as possible. This can delay the formation of the depression between the two impact surfaces, thereby achieving the effect of extending the overall life of the valve seat 913.

The conical surface 1220 of the valve seat is interference fit with the conical surface 1017 of the valve box. The conventional stepped valve seat and the valve box are positioned and installed by the valve seat step support step surface and corresponding valve box support step surface, which is prone to cracking. The stepless valve seat 913 of the implementations of FIGS. 9-12 (where there are no steps between the valve seat 913 and valve box 912) is achieved by the valve seat support surface 1121 and the valve box support surface 1018 being installed together, which is resistant to cracking.

In some example implementations, the guide cavity structure of the valve seat may be used in conjunction with the valve body claw structure to achieve a guiding effect on the movement direction of the valve body 1005.

In some example implementations, a stepless split valve seat for a fracturing plunger pump is disclosed as shown above, including a valve seat base and two liner rings. The two liner rings are located on the impact surface between the valve seat and the valve body assembly (including the valve body and the valve rubber). The hardness of the two liner rings is higher than that of the valve seat base. The impact surface 1122 of the large liner ring and the valve body assembly is mainly or entirely in contact with the valve rubber, and the impact surface 1123 of the small liner ring and the valve body assembly is mainly or entirely in contact with the valve body.

In some example implementations, the two liner rings above, namely the large liner ring and the small liner ring, are respectively installed in the valve seat base. After the large liner ring and the small liner ring are assembled in the valve seat base, the conical surfaces of the large liner ring and the small liner ring may be flush.

In some example implementations, the large liner ring and the small liner ring installed in the valve seat base may have a higher hardness than the hardness of the valve seat base, and the material or hardness of the two liner rings can be different.

In some example implementations, the two lining rings are respectively interference fit with the base of the valve seat, which can be cylindrical interference fit, conical interference fit, or other interference fit methods. Alternatively, when the valve seat is not installed in the valve box, the two lining rings are clearance fit with the base of the valve seat. When the entire valve seat is installed in the valve box, the valve seat and the valve box may be interference fit. Under the extrusion of the valve box, the two lining rings and the base of the valve seat change from the previous clearance fit to interference fit.

Compared with the solution of only embedding lining rings in the collision surface with the valve body, the large lining ring and small lining ring installed in the base of the valve seat in the solution above can effectively solve the problem of depression on the collision surface of the valve seat with the valve rubber after the long-term collision between the valve seat and the valve body

In some example implementations, the large liner ring and the small liner ring embedded in the base of the valve seat are made of materials with high hardness and wear resistance. The materials used for the large liner ring and the small liner ring include but are not limited to the following materials: zirconium oxide, nickel-based tungsten carbide, cobalt-based tungsten carbide, titanium carbide, boron nitride, ceramics, etc.

In some example implementation, the stepless split valve seat described above has no step structure in the structural design. A conical support surface is designed at the bottom of the valve seat. At the same time, a conical support surface is also designed at the valve seat installation position of the valve box. During the installation between the stepless split valve seat and the valve box, the conical surface is used instead of using the positioning shoulder. The installation and positioning operation of the valve seat is more convenient, which improves the efficiency of the disassembly and assembly of the valve seat.

In some example implementations, for the stepless split valve seat above, the conical surface of the valve seat and the conical surface of the valve box may be interference fit.

The stepless split-ring valve seat above with respect to FIGS. 9-12 provide several advantages. For example, the stepless structural design above can help avoid the problem of stress concentration at the root of the valve seat step from the valve seat structural design, avoid the risk of cracks and fractures at the root of the step of the valve seat during operation, and protect the valve box from leakage due to the fracture of the step at the root of the valve seat.

For another example, and to emphasize again, the stepless structural above uses a conical surface instead of a positioning shoulder in the installation and positioning between the valve seat and the hydraulic end valve box, making the installation and positioning operation of the valve seat more convenient, thereby improving the efficiency of disassembly and assembly of the valve seat.

For another example, and also to emphasize again, the stepless split valve seat disclosed above has two lining rings installed on the valve seat base. The two lining rings are located on the impact surface between the valve seat and the valve body assembly (including the valve body and the valve rubber). The hardness of these two lining rings is higher than that of the valve seat base, so that the impact surface between the valve seat and the valve body assembly is more wear-resistant, thereby extending the overall life of the valve seat, reducing the frequency of disassembly and assembly of the valve seat, and reducing the maintenance cost of the valve seat product.

For another example, in the stepless split valve seat above, the two lining rings on the valve seat can be made of high-hardness cemented carbide, ceramics, etc., while the base of the valve seat is ordinary alloy steel. Compared with the entire valve seat made of high-hardness cemented carbide, ceramics, etc., the price is lower and more cost-effective.

For another example, and also to emphasize again, the two lining rings on the valve seat disclosed above are independent of each other. The hardness of the two lining rings can be adjusted according to the actual situation, so that the wear degree of the two lining rings and the impact surface of the valve body and the valve rubber skin can be as consistent as possible, which can delay the formation of the depression between the two impact surfaces, thereby achieving the effect of extending the overall life of the valve seat, and can reduce the frequency of disassembly and assembly of the valve seat, and reduce the maintenance cost of the valve seat product. Compared with the conventional solution that only embeds hard alloy at the impact surface of the valve seat and the valve body, the implementations above also embeds high-hardness components at the position of the valve seat and the valve rubber skin, effectively solving the wear and depression problem of the impact surface of the valve seat and the valve rubber skin, and further extending the overall life of the valve seat.

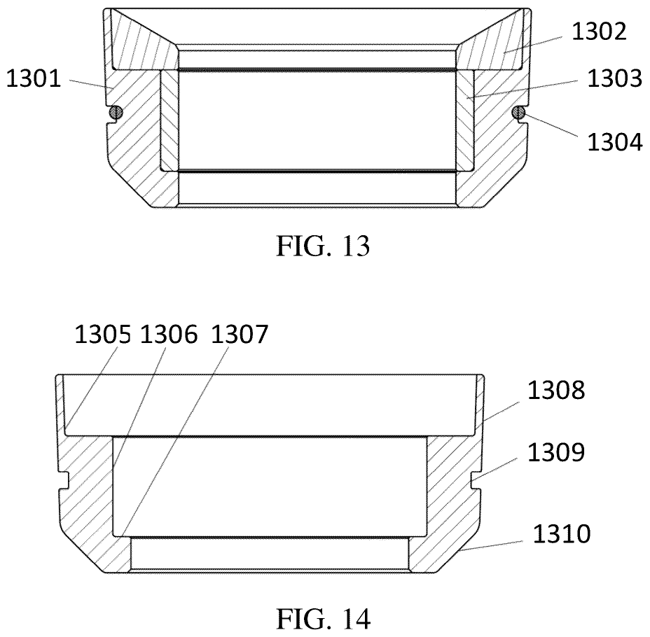

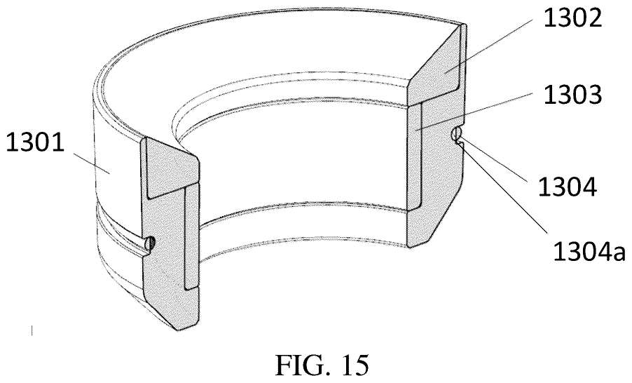

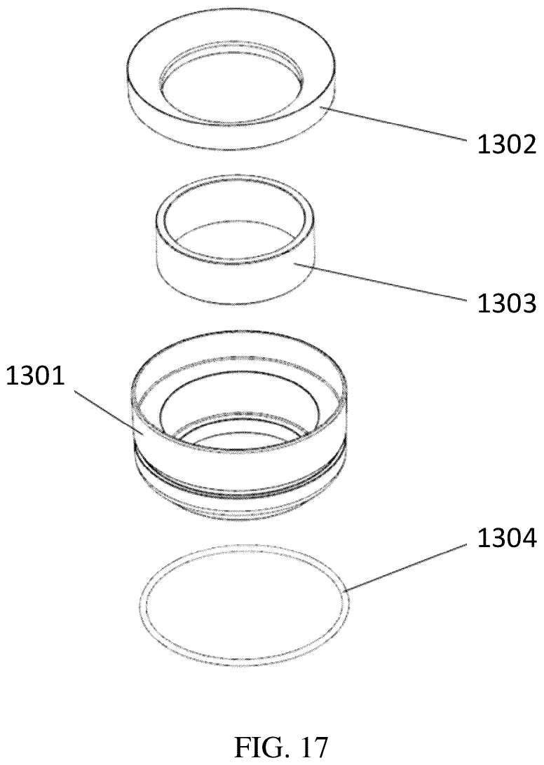

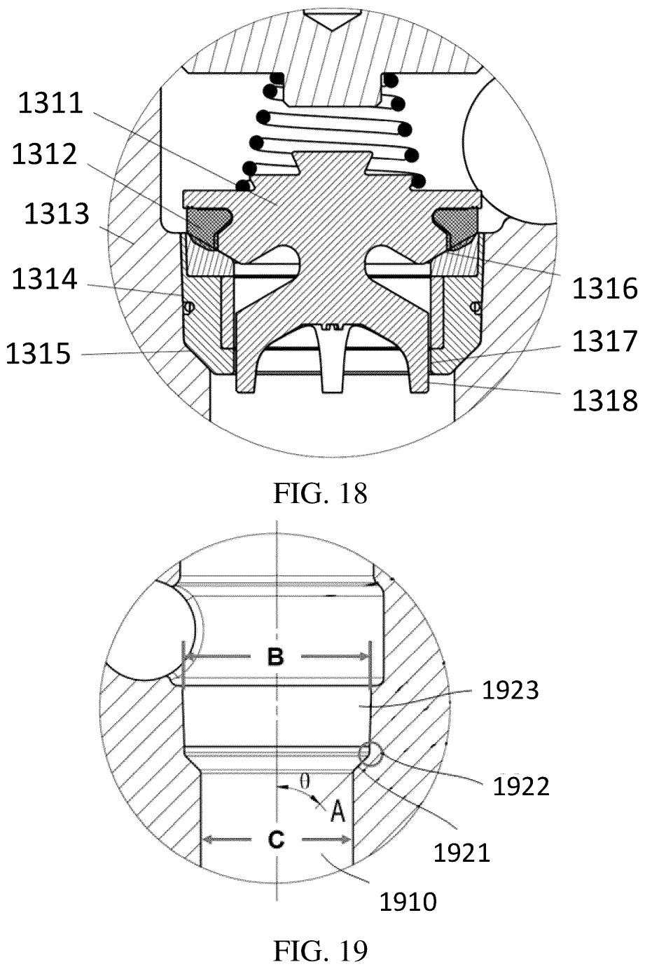

Some other example implementations are shown in FIGS. 13-18. FIGS. 13-1, shows a structure of valve seat for a plunger pump. The structure includes a valve seat base 1301, an impact surface lining ring 1302 (a first lining ring), an erosion surface lining ring 1303 (a second lining ring), and a sealing ring 1304. The impact surface lining ring 1302 is embedded in the impact surface lining ring installation groove 1305 (the first annular groove) of the valve seat base 1301, and the impact surface lining ring 1302 and the impact surface lining ring installation groove 1305 are interference fit. The erosion surface lining ring 1303 is embedded in the erosion surface lining ring installation groove 1306 (the second annular groove) of the valve seat base 1301, and the erosion surface lining ring 1303 and the erosion surface lining ring installation groove 1306 are interference fit. The sealing ring 1304 is assembled in the sealing groove 1309 of the valve seat. The first lining ring 1302 is disposed around the port at one end of the through cavity of the valve seat, and the second lining ring 1303 is disposed around the through cavity of the valve seat and docked with the first lining ring 1302. Based on this arrangement, the first lining ring 1302 can shield the inner wall at the port of the through cavity, and play a protective role to prevent the high-pressure fracturing fluid from eroding the port of the through cavity and causing damage to the valve seat; and the second lining ring 1303 can shield at least part of the inner wall in the through cavity, and play a protective role to prevent the high-pressure fracturing fluid from eroding at least part of the inner wall in the through cavity and causing damage to the valve seat.

In some example implementations, the end of the first lining ring 1302 facing the through cavity may be provided with a first conical surface, and correspondingly, the valve body may be provided with a second conical surface, and the inclination angles of the first conical surface and the second conical surface are consistent or are matched to ensure that the first conical surface can cooperate with the second conical surface when the valve body contacts the first lining ring 1302, thereby facilitating the improvement of contact sealing performance.

As such, after the impact surface lining ring 1302 is assembled on the valve seat base 1301, the conical surface of the impact surface lining ring 1302 is consistent with the angle of the valve body impact cone 1316 on the valve body 1311. The conical surface area of the impact surface lining ring 1302 is designed to be in contact with the valve body impact cone 1316 and the valve rubber 1312 area, and can withstand the impact of the valve body impact cone 1316 and the valve rubber 1312 on all the valve seat areas during the operation of the valve body. During the operation, the opening and closing of the conical surface of the impact surface lining ring 1302 of the valve seat and the conical surface of the valve body impact cone 1316 and the valve rubber 1312 control the opening and closing of the high-pressure fluid in the hydraulic end. Because the conical surface positions of the valve seat and the valve body frequently collide during operation, the impact surface lining ring 1302 needs to have higher hardness and wear resistance. In terms of material selection, it includes but is not limited to the following materials: zirconium oxide, nickel-based tungsten carbide, cobalt-based tungsten carbide, titanium carbide, boron nitride, etc.

Furthermore, the valve assembly may also include a valve rubber, which may be provided on the valve body 1311 or the first lining ring 1302, so as to ensure the sealing between the valve body 1311 and the first lining ring 1302 through the valve rubber, and may also play a buffering role between the valve body 1311 and the first lining ring 1302 to prevent the valve body 1311 from colliding with the first lining ring 1302 and causing damage to the components. In this way, during the operation, the opening or closing of the valve body 1311 controls the flow or stop of the fracturing fluid in the hydraulic end.

Moreover, by docking the first lining ring 1302 with second lining ring 1303, it can be ensured that there is no gap between the two, and the fracturing fluid is effectively prevented from contacting the inner wall of the valve through cavity through the gap between the first lining ring 1302 and the second lining ring 1303, so as to ensure that the inner wall of the valve through cavity is not eroded. Optionally, the first lining ring 1302 and the second lining ring 1303 may be annular structures, such as a circular ring structure, a polygonal ring structure, etc. Of course, they may also be other shapes, which are not specifically limited here. Accordingly, the cross section of the valve through cavity 11 can be circular, polygonal, etc.

The valve body 1311 is movably disposed with respect to the first lining ring 1302 and the second lining ring 1303 along the axial direction of the valve seat 1301, and the valve body 1311 is in contact with or separated from at least part of the inner surface of the first lining ring 1302. Based on this, the movement of the valve body 1311 can realize the opening or closing of the hydraulic end, thereby realizing the control of the fracturing fluid in the hydraulic end.

It should be noted here that the inner surface of the first lining ring 1302 is the inner wall surface of the first lining ring 1302. Optionally, the inner surface of the first lining ring 1302 may be a conical surface; of course, the inner surface of the first lining ring 1302 may also be composed of a conical surface and a cylindrical surface.

In some more specific embodiments, along the axial direction, the end of one end of the first lining ring 1302 may be provided with a first conical surface, and the end of the other end may be provided with a cylindrical surface; accordingly, the valve body 1311 may be provided with a second conical surface, so that after the valve body 1311 is installed, the first conical surface can be abutted against the second conical surface to achieve the support and limit function on the valve body 1311.

In addition, the valve body 1311 is located in the first lining ring 1302 and the second lining ring 1303, so that the valve body 1311 will not contact the inner wall of the valve through cavity, effectively preventing the reciprocating movement of the valve body 1311 from causing the inner wall of the valve through cavity to be worn.

The valve assembly in the embodiment of the present application can cover the port of the valve through cavity of the valve seat 1301 through the first lining ring 1302 to play a protective role, effectively preventing the valve body 1311 from directly hitting the port of the valve seat 1301 and causing damage to the port of the valve seat 1301, and can also prevent the fracturing fluid from directly eroding the port and causing damage to the port; the second lining ring 1303 can cover the inner wall of the valve through cavity of the valve seat 1301 to play a protective role, effectively preventing the fracturing fluid from directly eroding the inner wall of the valve through cavity and causing damage to the inner wall, and can also prevent the valve body 1311 from rubbing against the inner wall of the valve through cavity and causing damage to the inner wall. Based on the above configuration, the first lining ring 1302 and the second lining ring 1303 can replace the contact between the valve seat and the valve body 1311, reducing the friction, collision and impact of the valve seat 1301, effectively alleviating the problem of damage to the valve seat 1301, thereby extending the service life of the valve seat 1301, improving the utilization efficiency of the valve seat 1301, and reducing the consumption cost of the valve seat 1301.

In order to realize the installation of the first lining ring 1302 and the second lining ring 1303, a first annular groove 1305 and a second annular groove 1306 may be provided in the valve through cavity, wherein the first annular groove 1305 is located at the port at one end of the valve through cavity, and the second annular groove 1306 is located on the side of the first annular groove 1305 away from the port. Optionally, the first annular groove 1305 may be a circular groove, a polygonal groove, etc., and the second annular groove 1306 may be a circular groove, a polygonal groove, etc.

The first lining ring 1302 is provided in the first annular groove 1305 to ensure the reliability and stability of the installation between the first lining ring 1302 and the valve seat 1301; the second lining ring 1303 is provided in the second annular groove 1306 to ensure the reliability and stability of the installation between the second lining ring 1303 and the valve seat 1301. Further, along the radial direction of the valve seat 1301, the depth of the first annular groove 1305 is greater than the depth of the second annular groove 1306, that is, the cross-sectional area of the first annular groove 1305 in the radial direction of the valve seat 1301 is greater than the cross-sectional area of the second annular groove 1306 in the radial direction of the valve seat 1301. In this way, a first step structure can be formed at the connection between the first annular groove 1305 and the second annular groove 1306. In this way, after the first lining ring 1302 is arranged in the first annular groove 1305 and the second lining ring 1303 is arranged in the second annular groove 1306, the first step structure can be used to limit the first lining ring 1302 in the axial and radial directions of the valve seat 1301, so as to ensure the position accuracy and installation stability of the first lining ring 1302.

In addition, the inner circumference of the first lining ring 1302 can protrude the first annular groove 1305 along the radial direction of the valve seat 1301, and the end of the second lining ring 1303 can abut against the end face of the first lining ring 1302. In this way, the first lining ring 1302 can limit the second lining ring 1303 in the axial direction of the valve seat 1301 to ensure the position accuracy and installation stability of the second lining ring 1303.

In some embodiments, the outer wall of the first lining ring 1302 and the inner wall of the first annular groove 1305 are interference fit. Based on this, the first lining ring 1302 can be limited in the radial direction of the valve seat 1301 to ensure the installation stability of the first lining ring 1302 in the first annular groove 1305, and the first lining ring 1302 can be prevented from moving along the axial direction of the valve seat 1301 under the friction force, thereby ensuring that the first lining ring 1302 will not fall off the first annular groove 1305.

The outer wall of the second lining ring 1303 is interference fit with the inner wall of the second annular groove 1306. Based on this, the second lining ring 1303 can be limited in the radial direction of the valve seat 1301 to ensure the installation stability of the second lining ring 1303 in the second annular groove 1306, and under the condition of friction force, it can be ensured that the second lining ring 1303 will not move along the axial direction of the valve seat 1301.

In some embodiments, the end face of the first lining ring 1302 is flush with the end face of the first annular groove 1305, so that the first lining ring 1302 can completely cover the inner wall of the first annular groove 1305 to prevent the fracturing fluid from contacting the inner wall of the first annular groove 1305, and effectively prevent the fracturing fluid from eroding the inner wall of the first annular groove 1305. Along the axial direction of the valve seat 1301, the end face of the second lining ring 1303 is flush with the bottom of the first annular groove 1305. In this way, when the first lining ring 1302 is arranged in the first annular groove 1305, the end face of the first lining ring 1302 is flush with the bottom of the first annular groove 1305, so that the end face of the second lining ring 1303 can abut against the end face of the first lining ring 1302, so as to limit the second lining ring 1303 in the axial direction of the valve seat 1301 through the first lining ring 1302, and ensure the position accuracy and installation stability of the second lining ring 1303 in the axial direction.

In some embodiments, the inner wall of the first lining ring 1302, the inner wall of the second lining ring 1303 and the inner wall of the valve through cavity near the other end are arranged flush. Based on this, the inner wall of the first lining ring 1302, the inner wall of the second lining ring 1303 and the inner wall of the valve through cavity near the other end are used to guide and position the valve body 1311 to ensure the smooth movement of the valve body 1311 in the first lining ring 1302, the second lining ring 1303 and the valve through cavity, and to prevent the movement of the valve body 1311 from being obstructed and affecting its normal opening or closing.

Considering the frequent contact and even collision between the valve body 1311 and the first lining ring 1302 during the operation, in order to prevent the damage of parts, the material of the first lining ring 1302 can be wear-resistant material to prevent the back and forth movement of the valve body 1311 from causing wear to the first lining ring 1302, and can effectively prevent the fracturing fluid from eroding the first lining ring 1302, thereby extending the service life of the first lining ring 1302.

In addition, the first lining ring 1302 needs to have a higher hardness to ensure that the first lining ring 1302 can withstand friction and collision and extend the service life of the first lining ring 1302. Among them, the material of the first lining ring 1302 can be the same as or different from the material of the valve seat 1301, which can be selected according to the actual working conditions.

In order to ensure that the first lining ring 1302 is not easily deformed or damaged, the first lining ring 1302 can be made of a material with a higher hardness, wherein the hardness of the first lining ring 1302 can be the same as or different from the hardness of the valve seat 1301, which can be selected according to the actual working conditions.

Optionally, the material of the first lining ring 1302 can be cemented carbide or hard non-metallic material. Exemplarily, the first lining ring 1302 can be made of zirconium oxide, nickel-based tungsten carbide, cobalt-based tungsten carbide, titanium carbide or boron nitride, etc. Of course, it can also be made of other materials, as long as it can ensure that it has sufficient strength, rigidity, hardness, and wear resistance, and the specific material is not limited.

Considering that the valve body 1311 frequently rubs against the second lining ring 1303 during the operation, it is easy to cause the second lining ring 1303 to wear. In this way, the material of the second lining ring 1303 can be a wear-resistant material to prevent the back and forth movement of the valve body 1311 from causing wear to the second lining ring 1303, and it can also effectively prevent the fracturing fluid from eroding the second lining ring 1303, thereby extending the service life of the second lining ring 1303.

In addition, the material of the second lining ring 1303 can be the same as or different from the material of the valve seat 1301, and can be selected according to the actual working conditions. In order to ensure that the second lining ring 1303 is not easily deformed or damaged, the second lining ring 1303 can be made of a material with a relatively high hardness, wherein the hardness of the second lining ring 1303 can be the same as or different from the hardness of the valve seat 1301, and can be selected according to the actual working conditions. Optionally, the material of the second lining ring 1303 can be cemented carbide or hard non-metallic material. Exemplarily, the material of the second lining ring 1303 can be zirconium oxide, nickel-based tungsten carbide, cobalt-based tungsten carbide, titanium carbide or boron nitride, etc. Of course, it can also be other materials, as long as it can ensure that it has sufficient strength, rigidity, hardness, and wear resistance, and the specific material is not limited.

In addition, in the embodiment of the present application, due to the arrangement of the first lining ring 1302 and the second lining ring 1303, the strength, hardness, wear resistance, etc. of the valve seat 1301 in the contact area with the valve body 1311, the fracturing fluid, etc. can be improved, and the valve seat 1301 does not need to be subjected to carburizing quenching, induction quenching and other processes, so that the quality control process does not involve the control procedures of special processes such as carburizing quenching, induction quenching, etc., which simplifies the quality control work in the production process of the valve seat 1301 and better ensures the quality control of the production of the valve seat 1301.

Optionally, the first lining ring 1302 and the second lining ring 1303 can be made of wear-resistant materials, the valve seat 1301 is made of ordinary materials, and the hardness of the valve seat 1301 is lower than the hardness of the first lining ring 1302 and the second lining ring 1303. In this case, the performance in the contact area with the valve body 1311 and the fracturing fluid can be improved, and the overall cost of the valve assembly can be reduced. Of course, this form also has certain disadvantages. Specifically, when the seal of the valve body 1311 and the valve rubber fails, the high-pressure fracturing fluid will pierce the valve seat 1301 like a water knife, and the valve assembly needs to be removed from the valve box and replaced, which reduces the service life of the valve assembly.

In other embodiments, the first lining ring 1302, the second lining ring 1303 and the valve seat 1301 can all be made of wear-resistant materials with equal hardness. The advantage of this method is that when the seal of the valve body 1311 and the valve rubber fails, the high-pressure fracturing fluid will flush the valve seat 1301 like a water knife. However, the valve seat 1301 is made of wear-resistant material, which is not easily pierced by the fracturing fluid, so there is no need to replace the valve assembly, which is conducive to improving the service life of the valve assembly.

In addition, although the first lining ring 1302 and the second lining ring 1303 are made of wear-resistant materials, the long-term friction and collision of the valve body 1311 can easily cause the first lining ring 1302 and the second lining ring 1303 to wear. At this time, only the first lining ring 1302 and the second lining ring 1303 need to be replaced, and there is no need to replace the valve seat 1301, thereby reducing costs.

The disadvantages of the above method are: the first bushing 30, the second lining ring 1303 and the valve seat 1301 are all made of wear-resistant materials, which will lead to higher costs.

Based on the above valve assembly, the embodiment of the present application also discloses a hydraulic end of a plunger pump, and the disclosed hydraulic end includes a valve box and the above valve assembly.

Among them, the valve box can be provided with a cavity 1330 and a hydraulic channel, and the hydraulic channel is connected to the cavity 1330; in addition, the valve box can also be provided with a plunger channel 1323, and the plunger channel 1323 is connected to the cavity 1330. The plunger 1324 is movably arranged in the plunger channel 1323, so as to pressurize the fracturing fluid in the cavity 1330 through the reciprocating movement of the plunger 1324. The cavity 1330 is used to contain the fracturing fluid, and the fracturing fluid in the cavity 1330 is pressurized by the plunger 1324 to form a high-pressure fracturing fluid; the hydraulic channel can be divided into a liquid inlet channel 1325a and a liquid outlet channel 1325b, and the liquid inlet channel 1325a is used to allow the low-pressure fracturing fluid to enter the cavity 1330, and the pressurized fracturing fluid can be discharged through the liquid outlet channel 1325b for downstream transportation.

In addition, the hydraulic end can also include a packing assembly 04, which is arranged between the plunger 1324 and the plunger cavity to achieve sealing.

The valve seat 1301 is arranged in the liquid channel 1325, wherein the valve seat 1301 can be arranged in the liquid inlet channel 1325a, and the valve seat 1301 can also be arranged in the liquid outlet channel 1325b, so that the valve body 1311 can be installed through the valve seat 1301, and the liquid inlet channel 1325a or the liquid outlet channel 1325b can be opened or closed by the movement of the valve body 1311 relative to the valve seat 1301.

In order to ensure the installation stability of the valve assembly in the valve box, the outer wall of the valve seat 1301 and the inner wall of the liquid channel 1325 are interference fit, so that the inner wall of the liquid channel 1325 can realize the limiting effect of the valve seat 1301 in the radial direction, and ensure the installation stability of the valve seat 1301 in the radial direction. At the same time, under the action of friction, the limiting effect of the valve seat 1301 can also be realized in the axial direction, so as to ensure the installation stability of the valve seat 1301 in the axial direction.

In some embodiments, the liquid channel 1325 may include a first channel section, a transition section, and a second channel section, which are sequentially arranged along the flow direction of the fracturing fluid. Optionally, the liquid channel 1325 may be a liquid inlet channel 1325a, in which case the second channel section may be in communication with the cavity 1330 of the valve box, so that the external fracturing fluid flows into the cavity 1330 along the direction of the first channel section, the transition section, and the second channel section; in addition, the liquid channel 1325 may also be a liquid outlet channel 1325b, in which case the first channel section is in communication with the cavity 1330 of the valve box, so that the pressurized fracturing fluid in the cavity 1330 flows out of the cavity 1330 along the direction of the first channel section, the transition section, and the second channel section.

Furthermore, the cross-sectional area in the first channel section is smaller than the cross-sectional area in the second channel section, and the transition section is provided with a first inclined surface 1315 to achieve a transition connection between the inner wall of the first channel section and the inner wall of the second channel section through the first inclined surface 1315.

Correspondingly, the outer wall of one end of the valve seat 1301 can be provided with a second inclined surface (e.g., 1310 or 2011), and the second inclined surface abuts against the first inclined surface 1315. In this way, the valve seat 1301 can be stably supported by the abutment of the first inclined surface 1315 and the second inclined surface, thereby ensuring the stability of the installation of the valve seat 1301. In addition, since the first inclined surface 1315 and the second inclined surface are inclined along the axial direction of the valve seat 1301 and along the radial direction of the valve seat 1301, the first inclined surface can limit the second inclined surface in the axial direction and in the radial direction, thereby further ensuring the stability of the installation of the valve seat 1301.

Optionally, the first inclined surface and the second inclined surface can both be conical surfaces, and of course, they can also be other shapes, which are not specifically limited here.

It should be noted here that in the embodiment of the present application, the valve seat 1301 is a non-step valve seat 1301, and the first inclined surface 1315 and the second inclined surface are used to abut and match to achieve the installation and positioning of the valve seat 1301. Compared with the step method, the installation and positioning method in the embodiment of the present application can improve the convenience of installation and disassembly efficiency of the valve.

In order to further improve the sealing between the valve seat 1301 and the valve box, at least one of the outer wall of the valve seat 1301 and the inner wall of the liquid channel 1325 can be provided with a groove 1304a, and the hydraulic section can also include a sealing ring 1304, which is provided in the groove 1304a. In this way, the sealing between the valve seat 1301 (alternatively referred to as valve seat base) and the valve box can be improved by the sealing ring 1304, and the fracturing fluid can be effectively prevented from leaking from the gap between the valve seat 1301 and the valve box. Based on the above configuration, in the embodiment of the present application, the valve seat 1301 and the liquid channel 1325 of the valve box can achieve metal sealing through interference fit, and the sealing ring can also be sealed, thereby achieving double sealing between the valve seat 1301 and the valve box, effectively preventing the problem of fracturing fluid leakage between the valve seat 1301 and the valve box.

After the erosion surface lining ring 1303 is assembled on the valve seat base 1301, the lower end face of the erosion surface lining ring 1303 contacts the positioning step 1307 of the valve seat. The upper end face of the erosion surface lining ring 1303 is flush with the lower flat end face of the impact surface lining ring installation (or mounting) groove 1305 of the valve seat. The outer ring of the erosion surface lining ring 1303 and the inner ring of the erosion surface lining ring installation (or mounting) groove 1306 are interference fit, and the inner ring of the erosion surface lining ring 1303 is flush with the inner ring of the valve seat guide groove 1317. During operation, the inner ring of the erosion surface lining ring 1303 cooperates with the inner ring of the valve seat guide groove 1317 and the claw 1318 of the valve body to guide and position the valve body, so as to realize the up and down movement of the valve body. During operation, the erosion surface lining ring 1303 is subjected to the erosion of the high-pressure fluid and the wear of the reciprocating motion of the claw 1318. The erosion surface lining ring 1303 needs to have high wear resistance and erosion resistance. In terms of material selection, it includes but is not limited to the following materials: zirconium oxide, nickel-based tungsten carbide, cobalt-based tungsten carbide, titanium carbide, boron nitride, etc.

The impact surface lining (or liner) ring 1302 (the first lining ring) and the erosion surface lining (or liner) ring 1303 (the second lining ring) are assembled on the valve seat base 1301. During the operation, the embedded impact surface lining ring 1302 and the erosion surface lining ring 1303 replace the base to contact the valve body, reducing the impact on the valve seat base. In the failed valve seat, the impact surface lining ring 1302 and the erosion surface lining ring 1303 can be replaced to improve the utilization efficiency of the valve seat base and reduce the consumption cost of the valve seat.

In the design of a carbide liner ring structure of the valve seat above, the impact surface liner ring 1302 and the erosion surface liner ring 1303 may be independently designed. The impact surface liner ring 1302 may operate in contact with the impact surface of the valve body, and mainly bears the impact conditions of the valve body and the erosion conditions of the high-pressure fluid during the operation. The erosion surface liner ring 1303 works in contact with the claws, and mainly bears the reciprocating wear conditions of the claws of the valve body and the erosion conditions of the high-pressure fluid during the operation. Because the impact surface liner ring 1302 and the erosion surface liner ring 1303 are subjected to different working conditions during the operation, in the design of the material performance parameters of the impact surface liner ring 1302 and the erosion surface liner ring 1303, the material and required performance of the carbide material can be selected according to the working conditions, which is better suitable for the material performance required in each working area of the valve body, and effectively improves the service life of the impact surface and erosion surface of the valve seat.

The seal between the valve seat and the valve box may include two parts: metal seal and sealing ring seal. The metal seal refers to that the conical sealing surface 1308 of the valve seat is assembled with the conical sealing surface 1314 of the valve box 1313, and there is an interference fit between the two conical surfaces. The sealing is achieved by the interference fit between the metals. At the same time, a sealing groove 1309 is designed in the valve seat structure, and a sealing ring 1304 is installed in the sealing groove 1309. After the valve seat is assembled on the valve box, the sealing ring 1304 is located in the sealing groove 1309 of the valve seat and the conical sealing surface 1314 of the valve box, playing the role of a sealing ring.

The conventional step-type valve seat and the valve box are positioned and installed by the step structure of the valve seat and the step surface of the valve box. The step-free valve seat above is realized by the positioning installation surface 1310 of the valve seat (or the second inclined surface) and the valve box positioning installation surface 1315. The conical surface is used to replace the positioning shoulder, which makes the installation and positioning operation of the valve seat more convenient and improves the efficiency of disassembly and assembly of the valve seat.

The example implementations of FIGS. 13-18 provide various advantages. For example, In order to improve the wear resistance and erosion resistance of the impact surface between the valve seat and the valve body, and to improve the strength and hardness of the impact surface, a method of designing an embedded hard alloy at the impact surface of the valve seat is implemented above. Compared with the valve seat base, the hard alloy embedded at the impact surface of the valve seat has significantly improved strength and hardness, and the wear resistance and erosion resistance at the impact surface are significantly enhanced, which is better suitable for the working conditions of frequent collisions between the valve seat and the valve body and the impact of high-pressure fluid.

For another example, in order to improve the erosion resistance of the inner cavity of the valve seat a scheme of embedded hard alloy at the inner cavity of the valve seat is adopted above to improve the hardness of the inner cavity of the valve seat, thereby improving the erosion resistance of the inner cavity of the valve seat, and being more suitable to the working conditions where the inner cavity of the valve seat is subjected to the impact of high-pressure fluid during the action process.

For another example, two independent carbide rings are designed at the impact surface at the upper cone position of the valve seat and the erosion surface at the inner cavity position, which are in contact with the impact surface of the valve body and the high-pressure fluid in the inner cavity respectively. According to the different working conditions of the valve body impact and the high-pressure fluid erosion, the material and required performance of the carbide can be selected/adapted for the design of the working conditions, which is more suitable for the material performance required in each working area of the valve body, and effectively improves the service life of the impact surface and erosion surface of the valve seat.

For another example, during an operation of the valve seat, the collision surface at the upper cone position of the valve seat replaces the valve seat base to contact the valve body, reducing the impact on the valve seat base. The erosion surface at the inner cavity position of the valve seat replaces the valve seat base to contact the valve body, reducing the erosion on the valve seat base. In a failed valve seat, the utilization efficiency of the valve seat base can be improved by replacing the embedded carbide, and the maintenance cost of the valve seat can be reduced.

For another example, the valve seat of this patent does not require carburizing and quenching or induction quenching during the production process. As special processes, carburizing and quenching and induction quenching require strict quality control and require a large amount of manpower and material resources. Compared with the processing procedures of conventional valve seats, the processing procedures of the above implementations are simpler, and the quality control items of carburizing and quenching and induction quenching involved in the processing of the valve seat are removed, which simplifies the quality control process in the production process of the valve seat and better ensures the quality control of the production of the valve seat.

For another example, the valve seat disclosed in FIGS. 13-18 has an overall structural design of a step-free structure, which can avoid the problem of stress concentration at the root of the valve seat step from the valve seat structural design, avoid the risk of cracks and fractures at the root of the step of the valve seat during the operation, and protect the hydraulic end valve box from leakage due to the fracture of the step at the root of the valve seat.

For another example, the valve seat for a plunger pump disclosed in in FIGS. 13-18 effectively improves the impact resistance of the conical surface of the valve seat, effectively improving the erosion resistance of the inner cavity of the valve seat, and effectively avoiding the risk of cracking and failure at the root of the valve seat step, so that the service life of the valve seat is significantly improved, the frequency of disassembly and assembly of the valve seat is reduced, and the maintenance cost of the valve seat product is reduced.

In some example implementations of FIGS. 13-18, the valve seat for a plunger pump has a non-step structure in terms of structural design. The collision surface at the conical surface position on the valve seat and the erosion surface at the inner cavity position of the valve seat are designed with an embedded hard alloy structure. The outer side of the valve seat is designed as a conical surface structure, and a sealing groove is designed on the conical surface. A guide cavity is designed in the middle position of the valve seat.

In some example implementations of FIGS. 13-18, the valve seat does not involve carburizing quenching or induction quenching in the machining process, and does not involve special process control procedures for carburizing quenching or induction quenching in the quality control process, which simplifies the quality control work in the production process of the valve seat and better ensures the quality control of the valve seat production.

In some example implementations of FIGS. 13-18, the impact surface of the valve seat is a liner ring structure with embedded hard alloy. The outer ring of the liner ring and the inner ring of the installation groove are interference fit. The lower end face of the liner ring contacts the lower end face of the installation groove. The upper end face of the liner ring is flush with the upper end face of the valve seat base. The cone angle of the liner ring is consistent with the cone angle of the valve body impact. The cone area of the liner ring of the valve seat impact surface is in contact with the valve body impact cone surface and the valve rubber cone surface. It can withstand the impact of the valve body impact cone surface and the valve rubber on all impact areas of the valve seat during the operation of the valve body. The impact surface of the valve seat withstands the impact conditions of the valve body and the erosion conditions of the high-pressure fluid during the operation.

In some example implementations of FIGS. 13-18, the erosion surface of the valve seat is a liner ring structure with embedded cemented carbide. The outer ring of the liner ring and the inner ring of the installation groove are interference fit. The lower end face of the liner ring contacts the lower end face of the installation groove. The upper end face of the liner ring is flush with the upper end face of the installation groove, and the inner ring of the liner ring is flush with the inner ring of the guide groove. During the operation, the inner ring of the erosion surface liner ring and the inner ring of the valve seat guide groove cooperate with the claws of the valve body to guide and position the valve body, so as to realize the up and down movement of the valve body. During the operation, the erosion surface liner ring is subjected to the erosion conditions of high-pressure fluid and the wear conditions of the reciprocating motion of the claws.

In some example implementations of FIGS. 13-18, the impact surface lining ring and erosion surface lining ring of the valve seat are designed as a split structure. The impact surface lining ring and the erosion surface lining ring are designed independently. The impact surface lining ring contacts the impact surface of the valve body and mainly bears the impact working conditions of the valve body and the erosion working conditions of the high-pressure fluid during the operation. The erosion surface lining ring contacts the claws and mainly bears the reciprocating wear working conditions of the valve body claws and the erosion working conditions of the high-pressure fluid during the operation. Because the impact surface lining ring and the erosion surface lining ring are subjected to different working conditions during the operation, in the design of the material performance parameters of the impact surface lining ring and the erosion surface lining ring, the design of the working conditions is divided into the material and required performance of cemented carbide, which is better suitable for the material performance required in each working area of the valve body, and effectively improves the service life of the impact surface and erosion surface of the valve seat.

In some example implementations of FIGS. 13-18, the impact surface lining ring and erosion surface lining ring embedded in the valve seat base are made of materials with high hardness and wear resistance. The materials selected for the impact surface lining ring and erosion surface lining ring include but are not limited to the following materials: zirconium oxide, nickel-based tungsten carbide, cobalt-based tungsten carbide, titanium carbide, boron nitride, and the like.

The impact surface lining ring and erosion surface lining ring embedded in the valve seat can be replaced. During the operation of the valve seat, the impact surface lining ring and erosion surface lining ring are accustomed to withstand the impact of the valve body, the erosion of the high-pressure fluid, and the wear of the claws. In the failed valve seat, the utilization efficiency of the valve seat base can be improved by replacing the embedded cemented carbide, and the consumption cost of the valve seat can be reduced.

In some example implementations of FIGS. 13-18, the valve seat has no step structure in the structural design. A conical positioning and mounting surface is designed at the bottom of the valve seat. At the same time, a conical positioning and mounting surface is also designed at the valve seat mounting position of the valve box. In the installation between the stepless split valve seat and the valve box, a conical surface is used to replace the positioning shoulder. The installation and positioning operation of the valve seat is more convenient, which improves the efficiency of the valve seat disassembly and assembly.

In some example implementations of FIGS. 13-18, the seal between the valve seat and the valve box includes a metal seal and a sealing ring seal. The metal seal the conical sealing surface of the valve seat and the conical sealing surface of the valve box assembled together, and the two conical surfaces are interference fit. The interference between the two conical surfaces is controlled by the conical positioning and mounting surface of the valve seat and the valve box. The sealing is achieved by the interference fit between the metals. At the same time, a sealing groove is designed in the valve seat structure, and a sealing ring is installed in the sealing groove. After the valve seat is assembled on the valve box, the sealing ring is located in the sealing groove of the valve seat and the conical sealing surface of the valve box, which plays the role of sealing ring sealing.

Turning to the cavity in the valve box for accommodating the valve assemblies, as shown in FIG. 19, the hydraulic channel of the valve box may include a first channel section 1910, a second channel section 1923 and a transition section 1922 (as also described above). Along the flow direction of the fracturing fluid, the first channel section 1910, the transition section 1922 and the second channel section 1923 are connected in sequence so that the fracturing fluid can flow along the first channel section 1910, the transition section 1922 and the second channel section 1923. Moreover, the cross-sectional area in the first channel section 1910 is smaller than the cross-sectional area in the second channel section 1923, and the valve seat may be provided in the second channel section 1923 so as to support and limit the valve seat.

Considering that when the step structure of the valve seat above is avoided, although the outer wall of the valve seat does not form a transition zone, in order to achieve the support and limitation of the valve seat, a step structure needs to be formed in the liquid channel of the of the valve box, thereby forming a transition zone, and the transition zone then becomes a stress concentration zone. When the hydraulic end is operating, the fracturing fluid will transfer the pressure to the step structure of the valve box through the valve body and the valve seat, and this force changes periodically with the opening and closing of the valve body. As time goes by, cracks may appear in the transition zone of the valve box, and the cracks will easily expand rapidly, eventually causing the valve box to be scrapped.

Based on the above situation, as shown in FIGS. 19-21, the transition section 1922 can be provided with a inclined surface 1921 (similar to the first inclined surface 1315) arranged around the circumference of the transition section 1922, and accordingly, the outer wall of one end of the valve seat 2021 can be provided with a valve seat inclined surface 2011 (or the second inclined surface 1310) arranged around the circumference of the valve seat 2021, and the inclined surface 2011 (or 1310) of the valve seat abuts against the inclined surface 1921 (the first inclined surface).

In some example implementations, the inclined surface 1921 and the valve seat inclined surface 2011 can both be conical surfaces. In some more specific embodiments, the first inclined surface 1921 and the valve seat inclined surface 2011 can both be conical surfaces. Of course, they can also be other conical surfaces, which are not specifically limited here.

The embodiment of the present application can achieve the support and limit effect on the valve seat 2021 through the cooperation of the inclined surface 1921 and the inclined surface 2011 (or 1310) of the valve seat. Compared with the related art in which a step structure is provided on the outer wall of the valve seat 2021 to support the step structure through the valve box 2010, the transition zone structure formed by the step support is avoided, thereby effectively alleviating the problem of cracking caused by stress concentration in the step transition area of the valve seat 2021, and effectively preventing the valve box 2010 from being damaged by the leakage of fracturing fluid along the cracking position after the valve seat 2021 is cracked.

Compared with the step structure provided in the liquid channel of the valve box 2010, by providing the inclined surface 1921, the problem of stress concentration inside the valve box 2010 can be effectively alleviated, and the situation that cracks in the valve box 2010 cause the valve box 2010 to be scrapped can be effectively alleviated.

Further referring to FIG. 19-21, in some example embodiments, a first angle θ can be formed between the inclined extension direction of the inclined surface 1921 and the axial direction of the liquid channel, and correspondingly, a second angle can be formed between the inclined extension direction of the inclined surface 2011 of the valve seat and the axial direction of the valve seat 2021, and the first angle θ is equal to the second angle, so as to increase the contact area, improve the degree of fit, and ensure the sealing. By forming the first angle θ and the second angle, the stress concentration problem in the transition section 1922 and the stress concentration problem at one end of the valve seat 2021 can be alleviated.

Considering that the cross-sectional area in the second channel section 1923 is limited by the suction aperture or the discharge aperture of the valve box 2010, in principle, the smaller the suction aperture or the discharge aperture, the better, which can reduce the force on the suction cap or the discharge cap thread. In addition, the cross-sectional area of the first channel section 1910 is within the industry standard, and this dimension matches disassembly tools for the valve seat 2021. If the dimension changes, it will not only affect the disassembly but also the flow rate of the fracturing fluid.

In addition, the function of the inclined surface 1921 of the transition section 1922 is to support the valve seat 2021 so that the valve seat 2021 will not produce a large displacement under the action of pressure, and the displacement of the valve seat 2021 determines the support of the inclined surface 1921 to the valve seat 2021; and it is also necessary to reduce the stress at the inclined surface 1921 as much as possible so that cracks are not easy to occur at the transition section 1922.

Based on the above situation, simulation are performed when the first angle θ is 20°, 30°, 45°, 60°, 70°, 80°, and 90°, respectively, to obtain the optimal range of the first angle θ to minimize stress.

Under the above different angle values, the stress at the transition section 1922 is obtained via simulation, as shown in Table 1.

TABLE 1

| Angle A | 20° | 25° | 30° | 45° | 60° | 70° | 80° | 90° |
|---|---|---|---|---|---|---|---|---|
| Maximum stress in | 407.74 | 408.47 | 409.78 | 415.41 | 541.78 | 623.92 | 661.82 | 795.98 |
| transition zone/MPa | | | | | | | | |

Under the above different angle values, the displacement of the valve seat 2021 is also obtained, as shown in Table 2.

TABLE 2

| Angle A | 20° | 25° | 30° | 45° | 60° | 70° | 80° | 90° |
|---|---|---|---|---|---|---|---|---|
| Displacement/ | 0.53 | 0.42 | 0.34 | 0.21 | 0.16 | 0.15 | 0.15 | 0.15 |
| mm | | | | | | | | |

Based on the above simulation results, it can be seen that as the angle value increases, the stress at the transition section 1922 will increase, but the displacement of the valve seat 2021 will decrease, indicating that the inclined surface 1921 has better support for the valve seat 2021. It can be obtained that the range of the first angle θ is 25° to 70°, for example, including 25°, 30°, 35°, 40°, 45°, 50°, 55°, 60°, 65°, 70°, etc., of course, it can also be other degrees, which are not specifically limited here.

Correspondingly, the angle range of the above second angle can also be 25° to 70°, for example, including 25°, 30°, 35°, 40°, 45°, 50°, 55°, 60°, 65°, 70°, etc., of course, it can also be other degrees, which are not specifically limited here.

Based on the respective angle ranges of the first angle θ and the second angle, it is helpful to alleviate the stress concentration problem at the transition section 1922 and the end of the valve seat 2021 to prevent cracks.

Referring to the various figures above, in some example embodiments, the valve seat inclined surface 2011 is connected to the end surface of one end of the valve seat 2021, and at least part of the valve seat inclined surface 2011 extends to the first channel section 1910, and the end surface of one end of the valve seat 2021 is arranged opposite to the first channel section 1910. Based on this arrangement, the inclined surface 1921 can be completely covered by the valve seat inclined surface 2011 to prevent the fracturing fluid from directly scouring the inclined surface 1921, effectively preventing the inclined surface 1921 from being eroded.

It should be noted here that the valve seat 2021 is provided with a through hole, and the valve body is movably arranged in the through hole; the valve seat inclined surface 2011 extends obliquely from the outer wall of the valve seat 2021 toward the axial direction of the valve seat 2021. However, the end of the valve seat inclined surface 2011 is not directly connected to the inner wall of the through hole, but the end of the valve seat inclined surface 2011 is connected to the end face of the valve seat 2021, and the inner wall of the through hole is also connected to the end face of the valve seat 2021, so as to improve the strength at the end of the through hole and prevent the valve body from squeezing the valve seat 2021 and causing the valve seat 2021 to deform.

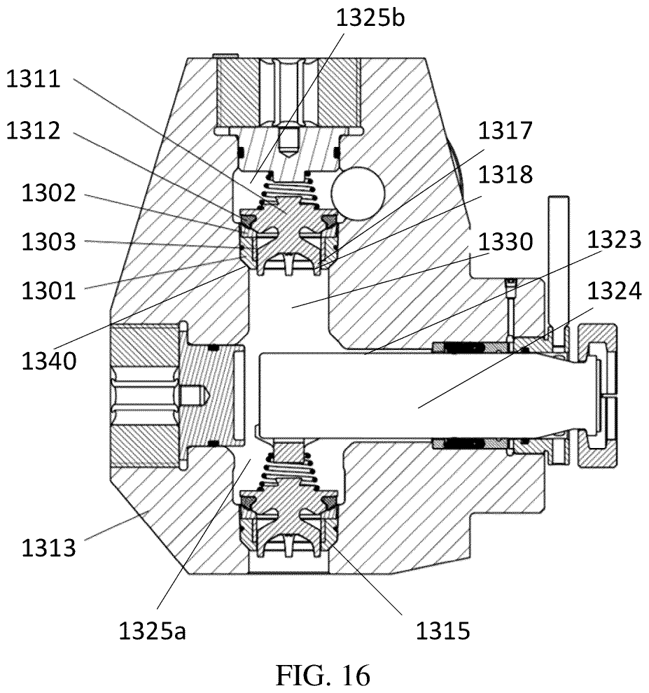

Referring to FIG. 16 and FIGS. 19-21, in some example embodiments, the liquid channel 1325 may include a liquid inlet channel 1325a and a liquid outlet channel 1325b, and the liquid inlet channel 1325a and the liquid outlet channel 1325b are respectively connected to the plunger channel 1323 and the cavity 1330, so as to facilitate the introduction of fracturing fluid into the cavity 1330 through the liquid inlet channel 1325a, and discharge the fracturing fluid in the cavity 1330 through the liquid outlet channel 1325b.

Among them, in the liquid inlet channel 1325a, the first channel section 1910 is arranged away from the cavity 1330, and the second channel section 1923 is arranged close to the cavity 1330, so that the fracturing fluid can enter the cavity 1330 of the valve box through the first channel section 1910 and the valve seat 2021 located in the second channel section 1923 in sequence, so as to realize the inflow of the fracturing fluid.

In the liquid outlet channel 1325b, the first channel section 1910 is arranged close to the cavity 1330, and the second channel section 1923 is arranged far away from the cavity 1330, so that the pressurized fracturing fluid can be discharged from the cavity 1330 through the first channel section 1910 and the valve seat 2021 located in the second channel section 1923 to the outside of the valve box 2010 to achieve the discharge of the fracturing fluid.

In some embodiments, the inclined surface 1921 abuts against the valve seat inclined surface 2011, so that the inclined surface 1921 can ensure the stable support of the valve seat inclined surface 2011 and the installation stability of the valve seat 2021. Of course, under the abutment effect, it can also help to improve the sealing between the inclined surface 1921 and the valve seat inclined surface 2011 to prevent the fracturing fluid from leaking between the inclined surface 1921 and the valve seat inclined surface 2011.

In addition, the outer wall of the valve seat 2021 and the inner wall of the second channel section 1923 can be interference fit, so that the installation stability of the valve seat 2021 can be ensured, and the sealing between the outer wall of the valve seat 2021 and the inner wall of the second channel section 1923 can be improved to prevent the fracturing fluid from leaking from the outer wall of the valve seat 2021 and the inner wall of the second channel section 1923.

In order to further improve the sealing between the outer wall of the valve seat 2021 and the inner wall of the second channel section 1923, the hydraulic end can also include a sealing ring 2030. As also described above, the sealing ring 2030 can be arranged between the outer wall of the valve seat 2021 and the inner wall of the second channel section 1923, so that the outer wall of the valve seat 2021 and the inner wall of the second channel section 1923 can form a better sealing to prevent the leakage of the fracturing fluid.

Among them, at least one of the outer wall of the valve seat 2021 and the inner wall of the second channel section 1923 can be provided with a groove described above, and the sealing ring 2030 is arranged in the groove. In this way, the contact area between the sealing ring 2030 and at least one of the outer wall of the valve seat 2021 and the inner wall of the second channel section 1923 can be increased, which is conducive to improving the sealing performance. In addition, the sealing ring 2030 can be limited by the side wall of the groove to prevent the sealing ring 2030 from moving at will.

Considering that the fracturing fluid contains fracturing sand and the flow rate of the fracturing sand is fast, in order to prevent the fracturing fluid from eroding the valve box, in the embodiment of the present disclosure, the end face of the other end of the valve seat 2021 away from the valve seat inclined surface 2011 is flush with the port of the second channel section 1923, or the end face of the other end of the valve seat 2021 away from the valve seat inclined surface 2011 protrudes from the port of the second channel section 1923. Based on this setting, the fracturing fluid can be effectively prevented from eroding the valve box body, thereby alleviating the problem of stress concentration at the erosion position, ensuring that cracks are not easily generated at the erosion position, and extending the service life of the valve box. Of course, in other embodiments, the port of the second channel section 1923 can protrude from the end face of the other end of the valve seat 2021 away from the valve seat inclined surface 2011.

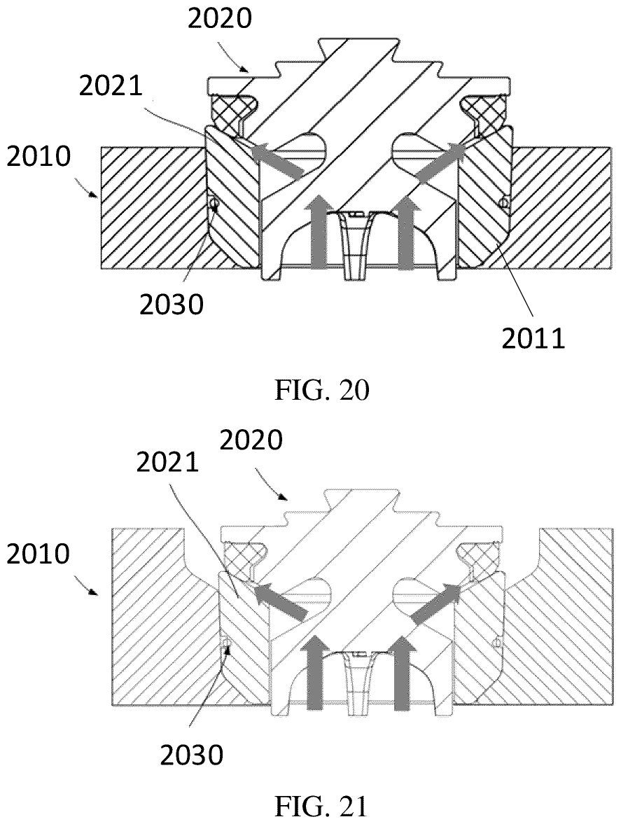

The valve seat 2021 of FIGS. 20 and 21 may be replaced with other valve seat configuration with wear-resistant rings as shown in FIGS. 1, 3, 5, 7, 11, 13, and any combination thereof.

Based on the valve assembly disclosed in any one of the above embodiments, an embodiment of the disclosure further discloses a plunger pump. The plunger pump includes a valve box 600 and the above valve assembly. The valve box 600 is provided with a limiting cavity. An inner diameter of the limiting cavity is equal to an outer diameter of the valve seat 100, and the valve seat 100 can be fixed to the limiting cavity in an interference fit manner such that the entire valve assembly can form a reliable assembly relationship with the valve box 600.

The above embodiments of the disclosure focus on the differences between the various embodiments. As long as different optimization features of the various embodiments do not contradict, the various embodiments can be combined to form better embodiments, which will not be repeated herein for brevity of text.

The above descriptions are merely embodiments of the disclosure and are not used to limit the disclosure. Those skilled in the art can make various changes and variations to the disclosure. Any modifications, equivalent substitutions, and improvements made within the spirit and principle of the disclosure shall fall within the scope of the claims of the disclosure.

What is claimed is:

1. A valve assembly, comprising:
a valve seat, a valve body;
valve rubber; and
at least one wear-resistant ring,
wherein:
the valve seat is provided with a guide cavity;
the valve body comprises a guide claw and an attachment disc which are fixedly connected;
the guide claw is in sliding fit with the guide cavity;
the attachment disc is provided with a mounting groove;
the valve rubber is embedded in the mounting groove;
the at least one wear-resistant ring and the valve seat are relatively fixed; and
when the valve assembly is in a closed state, the attachment disc and the valve rubber are both attached to a surface of the at least one wear-resistant ring.

2. The valve assembly according to claim 1, wherein the valve seat and the at least one wear-resistant ring are distributed in an axial direction of the valve seat and the guide cavity.

3. The valve assembly according to claim 2, further comprising a buffer ring, wherein hardness of the buffer ring is less than the hardness of the at least one wear-resistant ring, and the buffer ring is arranged around a periphery of the at least one wear-resistant ring.

4. The valve assembly according to claim 3, further comprising a buffer pad, wherein hardness of the buffer pad is less than the hardness of the at least one wear-resistant ring, the buffer pad and the buffer ring are fixedly connected, and the buffer pad is disposed between the valve seat and the at least one wear-resistant ring.

5. The valve assembly according to claim 1, wherein the valve seat comprises a seat body and a buffer portion which are fixedly connected, and the buffer portion is arranged around a periphery of the at least one wear-resistant ring.

6. The valve assembly according to claim 5, wherein the buffer portion is flush with an outer edge of the at least one wear-resistant ring in an axial direction of the valve seat.

7. The valve assembly according to claim 1, wherein the valve seat comprises a seat body and a buffer portion which are fixedly connected, and the buffer portion is embedded in an inner cavity of the at least one wear-resistant ring.

8. The valve assembly according to claim 7, wherein the buffer portion is recessed relative to an inner edge of the at least one wear-resistant ring toward a side away from the attachment disc in an axial direction of the valve seat.

9. The valve assembly according to claim 1, wherein the at least one wear-resistant ring is formed of a material comprising one of zirconium oxide, nickel-based tungsten carbide, cobalt-based tungsten carbide, titanium carbide, and boron nitride.

10. A plunger pump, comprising a valve box and the valve assembly according to claim 1, wherein the valve box is provided with a limiting cavity, and the valve seat is arranged in the limiting cavity in an interference fit manner.

11. The valve assembly according to claim 1, wherein the at least one wear-resistant ring comprises a first wear-resistance ring and a second wear-resistant ring.

12. The valve assembly according to claim 11, wherein:
the first wear-resistant ring is disposed between the valve rubber and the valve seat; and
the second wear-resistant ring is disposed between the valve body and the valve seat.

13. The valve assembly according to claim 12, wherein the first wear-resistant ring and the second wear-resistant ring are made of materials of different hardness for adapting to different wear conditions.

14. The valve assembly according to claim 1, wherein the guide cavity is lined with a corrosion resistant bushing.

15. The valve assembly according to claim 1, wherein the at least one wear-resistant ring is made of a wear-resistant material, hardness of the at least one wear-resistant ring is greater than hardness of the valve seat.

16. The valve assembly according to claim 11, wherein:
the first wear-resistant ring is located at an end port of the guide cavity;
the second wear-resistant ring is located along the guide cavity;
the first wear-resistant ring is larger than the second wear-resistance ring; and
the first wear-resistant ring butts against the second wear-resistant ring along an axial direction of the valve seat and the guide cavity.

17. The valve assembly according to claim 11, wherein:
the first wear-resistant ring is located at an end port of the guide cavity;
the second wear-resistant ring is located along the guide cavity;
the first wear-resistant ring is larger than the second wear-resistance ring; and
the first wear-resistant ring butts against the second wear-resistant ring along a radial direction of the valve seat and the guide cavity.

18. The valve assembly according to claim 1, wherein the valve seat comprises an inclined outer surface from an axial direction of the valve seat and the guide cavity at one end of the valve seat for installation of the valve seat to a match surface of a valve box.
